(19) United States
(12) Patent Application Publication
(10) Pub. No.: US 2013/0216157 A1
(43) Pub. Date: Aug. 22, 2013

(54) EMERGENCY ESCAPE BAG

(71) Applicants: Frank BOYNTON, Springfield, VA (US); Terry Lockard, Hamilton, VA (US)

(72) Inventors: Frank BOYNTON, Springfield, VA (US); Terry Lockard, Hamilton, VA (US)

(21) Appl. No.: 13/398,080

(22) Filed: Feb. 16, 2012

(51) Int. Cl. A62B 1/00; B65D 30/02; B65D 33/24; B65D 33/06

(52) U.S. Cl. 383/16

(57) ABSTRACT

The present disclosure provides systems and apparatuses for the safe evacuation of individuals, including children and pets, from burning buildings and other fire hazards.

### FIELD OF THE DISCLOSURE

The present disclosure relates to systems and apparatuses for the safe evacuation of individuals, including children and pets, from burning buildings and other fire hazards.

### BACKGROUND

Each year more than 4,000 Americans die, and more than 20,000 are injured, as a result of fires. Over 500 (13% of US fire fatalities) of these fatalities are children younger than 10 years old. The majority of these deaths occur in residential fires, and 91% of the fatalities in residential fires involve thermal burns and smoke inhalation. Bedrooms are the leading location (55%) where residential fatalities occur.

Successful preparation for escaping a fire requires a plan, familiarity with the plan and the necessary equipment to execute the plan. It is important to consider the threats posed by a fire environment while developing the escape plan. It would seem obvious that fire is hot, but it is, in actuality, much hotter than most people realize—and that heat alone, not just actual flames, can kill. Room temperatures in a fire can be 100 degrees at floor level but 600 degrees at eye level. Attempting to walk (in an upright position) out of this fire environment would place a person in air temperatures almost three times the boiling point of water. Within five minutes of a fire starting, a room can get so hot that everything in it will spontaneously ignite. Heat aside, fires emit toxic smoke and fumes which can also injure and kill.

Thus, survival depends on rapid escape from the fire environment, either out of the structure through a window, or by crawling to safety via another exit. The victim must avoid the threat environment as much as possible by remaining as close as possible to the ground. Crawling low enough to avoid the heat requires crawling in a nearly prone position. A critical challenge for a parent is how to crawl in this environment while carrying a child. If the child is small, the parent must be prepared to crawl while pulling the child or children along the floor, keeping them as low as possible. This is incredibly difficult. The temptation would be for the parent to carry the child in his or her arms, causing both parent and child to rise higher off of the floor, ultimately placing both individuals in a hotter environment and exposing them to greater danger.

Many American families also have pets—dogs and cats or other small animals. Similarly, these families want to evacuate their home with their pet when possible. In emergency escape situations, pets often can be a greater challenge to carry than infants while crawling or descending an emergency escape ladder. Furthermore, pets can be at risk for injury or loss once they are safely on the ground if they cannot be secured by the owner or first responder.

Because many US houses are multi-story (with the bedrooms typically on the higher floors) evacuating to safety from a second or higher floor often requires some form of equipment. This may take the form of an escape ladder or similar apparatus. Many escape ladders are collapsible devices—rope, for example—and are therefore not very rigid. OSHA recommends that individuals always maintain a three-point contact while descending a ladder (e.g., by using two hands and one foot, or two feet and one hand) and that individuals should not hold any objects in their hands while using a ladder. A key escape challenge for a person in this situation is how to safely climb down a non-rigid escape ladder while carrying a child or a pet, while complying with the guidance to maintain three-point contact.

What is needed is a device or apparatus to protect the occupant, whether a child or a pet, and allow a parent or pet owner to safely escape a fire environment with an infant, toddler, young child or pet, wherein the apparatus can be:

dragged by an individual who is crawling;

securely carried hands-free by an individual climbing down an emergency ladder; and/or

lowered to the ground while the apparatus securely contains a child or pet.

### SUMMARY

This summary is provided to introduce a selection of concepts in a simplified form that are further described below in the Detailed Description. This summary is not intended to identify key features or essential features of the claimed subject matter, nor is it intended to be used to limit the scope of the claimed subject matter.

In one aspect of the present disclosure, an emergency escape bag is provided so as to allow for the safe removal of children and/or pets from hazardous situations, such as residential house fires. Such an emergency escape bag may comprise one or more pieces of flame-resistant fabric providing at least the bottom and sides of the bag; one or more vertically-oriented lifting straps attached to the bag so as to provide one or more vertically-oriented handles, such that at least one of these handles may be looped over an individual's head or shoulders; and one or more horizontally-oriented lifting straps attached to the fabric so as to provide one or more drag handles.

In another aspect according to the present disclosure, an emergency escape bag may further comprise a lowering strap system having a lowering strap pouch configured to removably attach to the emergency escape bag; and a lowering strap configured to removably attach to the emergency escape bag and which may be stored in the emergency escape bag.

In yet another aspect according to the present disclosure, an emergency escape bag may further comprise an emergency leash system having an emergency leash pouch configured to removably attach to the emergency escape bag; and an emergency leash which may be stored in the emergency escape bag.

### BRIEF DESCRIPTION OF THE DRAWINGS

FIG. 1 is a perspective view of an exemplary escape bag according to the present disclosure.

FIG. 2 is a top view of an exemplary escape bag according to the present disclosure.

FIG. 3 is a side view of an exemplary escape bag according to the present disclosure showing a lowering strap system.

### DETAILED DESCRIPTION

An escape bag according to the present disclosure permits an individual to safely escape a fire environment with an infant, toddler, young child or pet.

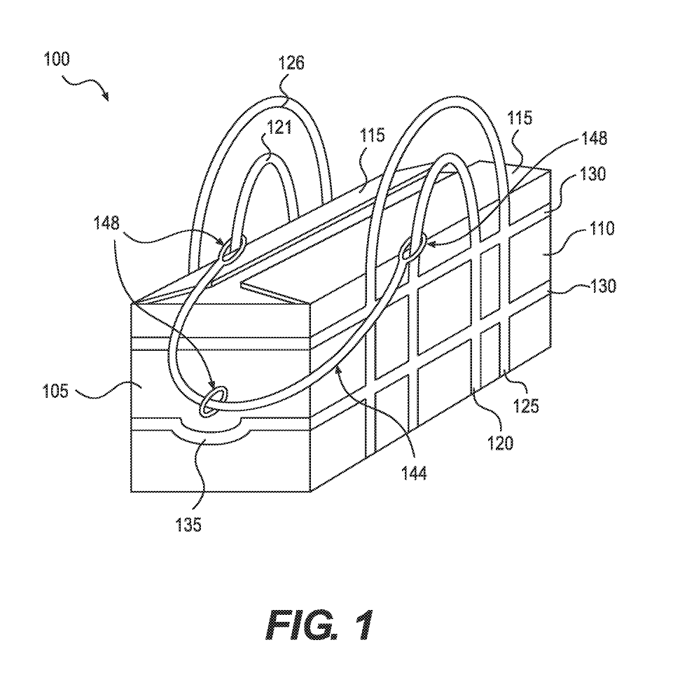

In an exemplary embodiment, as shown in FIG. 1, an escape bag 100 may comprise two main pieces of flame-resistant fabric, such as 13- or 14-ounce, 100% cotton flame-resistant duck cloth. A first piece may form the “ends” of the bag, shown as 105 on FIG. 1, and one layer of the bottom of the bag. A second piece may form the “sides” of the bag, shown as 110 on FIG. 1, and a second thickness of the bottom of the bag. It will, of course, be understood that the foregoing description is merely exemplary and the bag 100 need not be made from two pieces of fabric in this manner, but can be made in any suitable manner (such as, for example, from one continuous piece of fabric, or from several pieces of fabric stitched together).

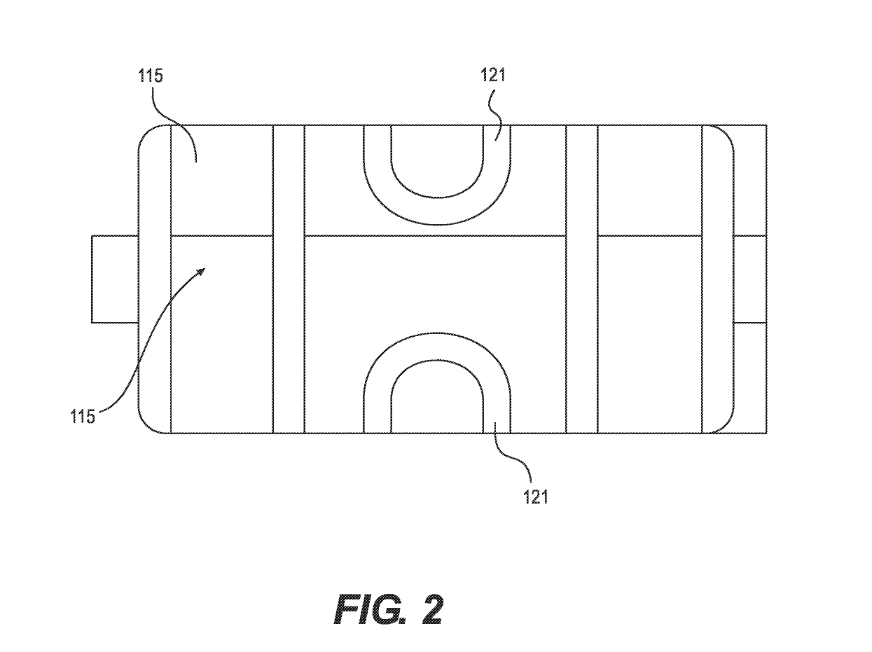

As shown on FIGS. 1 and 2, in this exemplary embodiment, the top of the bag, formed by the second piece 110, may have two large overlapping flaps 115 which may be securable (and removable) by, for example, Velcro® or some other form of quick-attach and/or release mechanism. This may be used to prevent the occupant of the bag from falling out or otherwise escaping the bag, while ensuring that adequate air flow permits the occupant to breathe. Similarly, it will be understood that this use of two flaps is merely exemplary, and any suitable method may be used for ensuring that the occupant stays within the bag 100 during transit.

One or more sides of the bag may optionally have Velcro® (or other appropriate material) patches for connecting optional pouches, as will be described in further detail below.

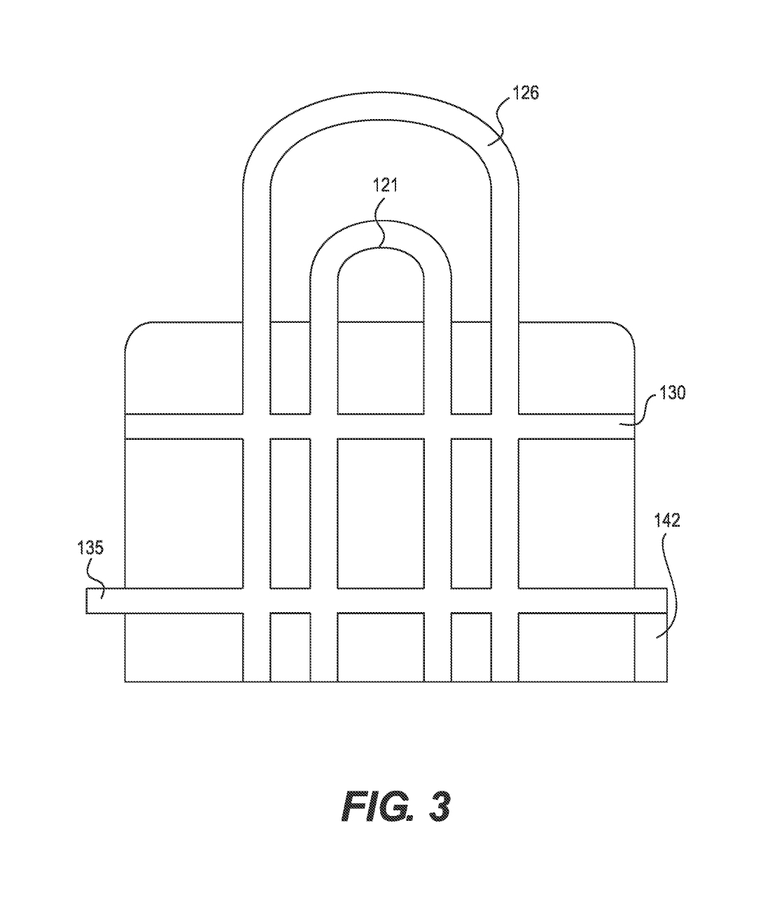

As shown on FIGS. 1 and 3, lifting straps may be attached to the bag 100 such that the straps appear vertical when the bag is resting on its bottom face. These lifting straps 120, 125 may be formed of heavy-duty webbing, such as MilSpec A-A-55301 Type I Webbing, 2.25″ in width, and having a 2000 lbs breaking strength rating. This webbing may further be outfitted with reflective tape, or some other mechanism providing a reflective surface, to provide greater visibility to the bag. The lifting straps 120,125 may be shaped in a continuous circle or oval, so as to attach to and pass completely under the bag 100, and may be stitched to the bag at all (or substantially all) places where the strap contacts the fabric. This may create an integrated lifting and carrying capability, transferring some of the weight of the occupant from the fabric 105, 110 to the heavy-duty lifting straps 120, 125.

The first lifting strap 120 may be configured so as to provide handles 121, permitting an individual to hold the bag using his or her hands. These handles 121 may provide, by way of example only, an opening of approximately 6″ tall and 6″ wide. The second lifting strap 125 may be configured to provide larger handles or loops 126, such as, for example, 18″ tall and 18″ wide. This second lifting strap 125 may allow the bag to slip over the head of an individual so as to allow for, by way of example only, hands-free carrying down a ladder.

The bag may also comprise one or more horizontal straps 130, which may be sewn to the cloth and/or the vertical straps 120, 125. These horizontal straps 130, much like the lifting straps 120,125 may be formed of heavy-duty webbing. The horizontal straps 130 also may be stitched down at all strap intersections and at all (or substantially all) locations where the straps 130 come into contact with the bag, so as to improve the overall strength of the bag 100. As shown on FIGS. 1 and 3, these horizontal straps 130 may also be used to create a drag handle 135. This would permit an individual to pull a protected occupant while the individual crawls to avoid heat, smoke or flame. For example, this might allow a first responder to pass a child or a pet to an individual on the ground, permitting the first responder then to proceed down the ladder with the use of both hands—increasing the safety of both the first responder and child.

In certain embodiments, the bag further may include a lowering strap system which may be used to lower the bag from a second-floor (or higher) window to the ground. The lowering strap system may first comprise a lowering strap pouch 142, which may be attached to the side of the bag 100 via Velcro® or some other form of quick-attach and/or release mechanism. A lowering strap 144 may be stored in the lowering strap pouch 142. The lowering strap 144 may be created from a single or double-thickness of heavy-duty webbing; the double-thickness may be preferred in certain embodiments so as to enhance the overall strength of the strap 144. The lowering strap 144 may be any length suitable for lowering the bag 100 from high locations. For example, a 50′ length may be suitable for lowering a bag from the second or third floor of many buildings. The lowering strap 144 may be folded accordion-style into the pouch 142 so as to allow for easy, tangle-free extraction of the strap 144.

Each end of the lowering strap 144 may possess a connector 148 suitable for attaching the lowering strap 144 to the bag 100. For example, the connector 148 may be a snap-link, D-ring, or any other suitable form of connector which may be used to quickly and securely attach and detach the strap 144 to the handles 121 provided by the first lifting strap 120. The snap-link (or other similar type device) may facilitate the parent or owner attaching the lowering strap to the bag, and further may facilitate rescue personnel's rapid retrieval of the bag, allowing him/her to detach it from the lowering strap and quickly move the bag containing the child or pet away from the burning building to safety.

The bag also may include a woolen blanket (not shown) which may serve to protect the occupant from heat within the burning building, bumps and jars during evacuation, and then from cold temperatures post-evacuation. The blanket may measure, for example, 24″ by 36″.

In certain embodiments, the bag 100 may be optimized for use specifically with children. In one such embodiment, the escape bag 100 may be lined with flame-resistant quilt lining, such as 10.5 ounce quilt lining. The bag 100 may be specifically sized for children, as well. For example, an infant carrying bag might be 36″ long and 12″ wide and rated to hold up to 27 lbs, suitable for carrying children up to 12 months in age in up to the 95^{th} percentiles for weight and height. A toddler carrying bag might be 41″ long and 12″ wide and rated to hold up to 42 lbs, suitable for carrying children up to 24 months in age in up to the 95^{th} percentiles for weight and height. It will be understood, however, that the foregoing measurements are merely exemplary and the bag may be sized in any way as desired.

In other embodiments, the bag 100 may be optimized for use specifically with pets. For example, in one such embodiment the bag may also comprise an emergency leash system (not shown). This will allow for ease of handling and monitoring pets, under controlled circumstances, following evacuation of the pet from the building. The emergency leash system may comprise an emergency leash pouch, configured to attach to the side of the bag 100 via, for example, Velcro®. An emergency leash may be stored within the pouch, such as, by way of example, a 10′ slip-loop leash.

The bag may be specifically sized for pets, as well. For example a small-sized pet bag might be 24″ long and 16″ wide and rated for 25 lbs, designed for carrying cats, or miniature breed dogs. A medium sized-pet bag might be 36″ long and 24″ wide and rated for 40 lbs, meant for carrying medium-sized dogs up to 20″ tall at the shoulder (e.g., Australian Cattle Dogs). A large-sized pet bag might be intended for use with large dogs up to 30″ tall at the shoulder (e.g., Golden Retrievers), 42″ long and 24″ wide and rated for 75 lbs. Again, it will be understood, however, that the foregoing measurements are merely exemplary and the bag may be sized in any way as desired.

The pet bag may or may not be lined.

1. An emergency escape bag for use by an individual to transport an occupant from a hazardous environment comprising:
one or more pieces of flame-resistant fabric providing at least the bottom and sides of the bag;
one or more vertically-oriented lifting straps attached to the bag so as to provide one or more vertically-oriented handles, wherein at least one of such vertically-oriented lifting straps may be looped over the individual's head or shoulders such that the individual may carry the bag without using his or her hands; and
one or more horizontally-oriented lifting straps attached to the fabric so as to provide one or more drag handles.

2. The emergency escape bag according to claim 1 wherein the one or more pieces of flame-resistant fabric further provide a top to the bag.

3. The emergency escape bag according to claim 2 wherein the top of the bag is formed of two overlapping and securable flaps.

4. The emergency escape bag according to claim 1 further comprising a lowering strap system, the lowering strap system comprising: a lowering strap pouch configured to removably attach to the emergency escape bag; and a lowering strap configured to removably attach to the emergency escape bag and which may be stored in the emergency escape bag.

5. The emergency escape bag according to claim 1 further comprising an emergency leash system, the emergency leash system comprising: an emergency leash pouch configured to removably attach to the emergency escape bag; and an emergency leash which may be stored in the emergency escape bag.

6. The emergency escape bag according to claim 1 wherein the one or more pieces of flame-resistant fabric providing at least the bottom and sides of the bag are specifically sized to transport an infant, such that the length of the bag does not exceed 36″ and the width of the bag does not exceed 12″, and wherein the bag is further rated to transport a total weight not to exceed 27 lbs.

7. The emergency escape bag according to claim 1 wherein the one or more pieces of flame-resistant fabric providing at least the bottom and sides of the bag are specifically sized to transport a toddler, such that the length of the bag does not exceed 41″ and the width of the bag does not exceed 12″, and wherein the bag is further rated to transport a total weight not to exceed 42 lbs.

8. The emergency escape bag according to claim 1 wherein the one or more pieces of flame-resistant fabric providing at least the bottom and sides of the bag are specifically sized to transport a small-sized pet, such that the length of the bag does not exceed 24″ and the width of the bag does not exceed 16″, and wherein the bag is further rated to transport a total weight not to exceed 25 lbs.

9. The emergency escape bag according to claim 1 wherein the one or more pieces of flame-resistant fabric providing at least the bottom and sides of the bag are specifically sized to transport a medium-sized pet, such that the length of the bag does not exceed 36″ and the width of the bag does not exceed 24″, and wherein the bag is further rated to transport a total weight not to exceed 40 lbs.

10. The emergency escape bag according to claim 1 wherein the one or more pieces of flame-resistant fabric providing at least the bottom and sides of the bag are specifically sized to transport a large-sized pet, such that the length of the bag does not exceed 42″ and the width of the bag does not exceed 24″, and wherein the bag is further rated to transport a total weight not to exceed 75 lbs.

11. The emergency escape bag according to claim 1 wherein at least one of such vertically-oriented lifting straps is attached to and passes under the bottom of the bag, so as to transfer at least some of the weight of the occupant from the fabric to said vertically-oriented lifting strap.

12. The emergency escape bag according to claim 1 wherein at least one of such horizontally-oriented lifting straps is attached to the fabric and to at least one of the vertically-oriented straps so as to transfer at least some of the weight of the occupant from the fabric to said horizontally-oriented lifting strap and to said vertically-oriented lifting strap.

13. The emergency escape bag according to claim 1 wherein at least a second vertically-oriented lifting strap is attached to the bag so as to provide at least a second vertically-oriented handle, such that the individual may carry the bag via the second vertically-oriented handle using his or her hands.

14. The emergency escape bag according to claim 13 wherein the second vertically-oriented lifting strap is attached to and passes under the bottom of the bag, so as to transfer at least some of the weight of the occupant from the fabric to said second vertically-oriented lifting strap.

15. The emergency escape bag according to claim 14 wherein at least one of such horizontally-oriented lifting straps is attached to the fabric and to at least one of the vertically-oriented straps so as to transfer at least some of the weight of the occupant from the fabric to said horizontally-oriented lifting strap and to said vertically-oriented lifting strap.

16. The emergency escape bag according to claim 4 wherein the lowering strap system is attached to one or more of the vertically-oriented handles of the emergency escape bag, such that the emergency escape bag can be lowered vertically.

17. The emergency escape bag according to claim 16 wherein the lowering strap is at least 50 feet long.

18. The emergency escape bag according to claim 1 further comprising a flame-resistant quilt lining.
